(19) United States
(12) Patent Application Publication
(10) Pub. No.: US 2026/0098752 A1
(43) Pub. Date: Apr. 9, 2026

(54) SYSTEMS AND METHODS FOR CONFIGURING FLOW METERS

(71) Applicant: Chevron U.S.A. Inc., San Ramon, CA (US)

(72) Inventors: Fathollah Gozalpour, Houston, TX (US); Pamela Isobel Chacon, Magnolia, TX (US); Flavia Viana, Katy, TX (US)

(21) Appl. No.: 18/906,037

(22) Filed: Oct. 3, 2024

(51) Int. Cl. G01F 25/10

(52) U.S. Cl. CPC G01F 25/10

(57) ABSTRACT

Measured values of fluid properties for oil, gas, and water at particular operating temperature and operating pressure in a pipe are used to develop fluid phase equilibrium model to calculate fluid properties at other operating temperatures and operating pressures in the pipe. The developed fluid phase equilibrium model is used to generate a fluid property look-up table that establishes correspondence between values of operating temperatures and operating pressures and values of fluid properties for oil, gas, and water. A flowmeter is configured to directly use the fluid property look-up table to measure flowrates of oil, gas, and water in the pipe.

### FIELD

The present disclosure relates generally to the field of flowmeters that measure flowrates of oil, gas, and water in a pipe.

### BACKGROUND

Flowmeters may be used to measure flowrates in pipes. Flowmeters may be configured to measure flowrates using polynomials fitted to fluid properties over broad ranges of pressure and temperature. However, such configuration of flowmeters could result significant errors in flowrate measurement.

### SUMMARY

This disclosure relates to configuring flowmeters. Measured values of fluid properties for oil, gas, and water in a pipe at an operating temperature and an operating pressure may be obtained. Fluid phase equilibrium modeling for the pipe may be performed based on the measured values of fluid properties for oil, gas, and water in the pipe at the operating temperature and the operating pressure. The fluid phase equilibrium modeling may be performed to determine modeled values of fluid properties for oil, gas, and water in the pipe at different operating temperatures and different operating pressures. A fluid property look-up table may be generated based on the modeled values of fluid properties for oil, gas, and water in the pipe at the different operating temperatures and the different operating pressures and/or other information. The fluid property look-up table may establish correspondence between values of operating temperatures and operating pressures and values of fluid properties for oil, gas, and water. A flowmeter may be configured to directly use the fluid property look-up table to measure flowrates of oil, gas, and water in the pipe. The flowmeter may interpolate between the values of operating temperatures and operating pressures and the values of fluid properties for oil, water, and gas in the fluid property look-up table to determine applicable values of fluid properties for oil, water, and gas in measuring the flowrates of oil, water, and gas in the pipe.

A system for configuring flowmeters may include one or more electronic storage, one or more processors, and/or other components. The electronic storage may store information relating to fluid, information relating to fluid properties, information relating to oil, information relating to gas, information relating to water, information relating to a pipe, information relating to operating temperatures, information relating to operating pressures, information relating to fluid phase equilibrium modeling, information relating to a fluid property look-up table, information relating to a flowmeter, and/or other information.

The processor(s) may be configured by machine-readable instructions. Executing the machine-readable instructions may cause the processor(s) to facilitate configuring flowmeters. The machine-readable instructions may include one or more computer program components. The computer program components may include one or more of a fluid measurement component, a modeling component, a table component, a flowmeter component, and/or other computer program components.

The fluid measurement component may be configured to obtain measured values of fluid properties for one or more fluids in a pipe. The fluid measurement component may be configured to obtain measured values of fluid properties for oil, gas, water, and/or other fluids in the pipe. The measured values of fluid properties for fluid(s) may be obtained at one or more operating temperatures and one or more operating pressures. The measured values of fluid properties for oil, gas, water, and/or other fluids may be obtained at one or more operating temperatures and one or more operating pressure.

In some implementations, the fluid properties for fluids (oil, gas, and/or water) may include oil density, oil volume factor, oil viscosity, gas density, gas volume factor, gas phase condensate ratio, stock tank gas-oil ratio, water density, water volume factor, water viscosity, stock tank gas-water ratio, and/or other fluid properties.

In some implementations, the pipe may be located at a reservoir. The measured values of fluid properties for fluids (oil, gas, and/or water) in the pipe may be obtained at beginning of production from the reservoir. In some implementations, updated values of fluid properties for fluids in the pipe may be obtained during the production from the reservoir.

The modeling component may be configured to perform fluid phase equilibrium modeling for the pipe The fluid phase equilibrium modeling may be performed based on the measured values of fluid properties for fluids (oil, gas, and/or water) in the pipe at the operating temperature(s) and the operating pressure(s). The fluid phase equilibrium modeling may be performed to determine modeled values of fluid properties for fluids (oil, gas, and/or water) in the pipe at different operating temperatures and different operating pressures.

In some implementations, the fluid phase equilibrium modeling may be reperformed based on the updated values of fluid properties for fluids (oil, gas, and/or water) in the pipe to determine new modeled values of fluid properties for fluids in the pipe.

The table component may be configured to generate one or more fluid property look-up tables. A fluid property look-up table may be generated based on the modeled values of fluid properties for fluids (oil, gas, and/or water) in the pipe at the different operating temperatures and the different operating pressures and/or other information. A fluid property look-up table may establish correspondence between values of operating temperatures and operating pressures and values of fluid properties for fluids (oil, gas, and/or water). A fluid property look-up table may establish correspondence between the values of operating temperatures and operating pressures and the values of fluid properties for fluids for one or more ranges of operating temperatures and one or more ranges of operating pressures.

In some implementations, a fluid property look-up table may include a black oil table.

In some implementations, one or more updated fluid property look-up tables may be generated based on the new modeled values of fluid properties for fluids (oil, gas, and/or water in the pipe and/or other information.

The flowmeter component may be configured to configure one or more flowmeters. A flowmeter may be configured to directly use the fluid property look-up table(s) to measure flowrates of fluids (oil, gas, and/or water) in the pipe. A flowmeter may be configured to interpolate between the values of operating temperatures and operating pressures and the values of fluid properties for fluids (oil, water, and/or gas) in the fluid property look-up table(s) to determine applicable values of fluid properties for fluids in measuring the flowrates of fluids in the pipe. In some implementations, a flowmeter may be configured to directly use the updated fluid property look-up table(s) to measure the flowrates of fluids in the pipe.

In some implementations, process calculation may be performed based on the fluid property look-up table and/or other information.

In some implementations, a flowmeter may be configured to directly use the fluid property look-up table without using polynomials fitted to the values of operating temperatures and operating pressures and the values of fluid properties for fluids (oil, gas, and/or water) in the fluid property look-up table.

In some implementations, responsive to an applicable temperature being within the range of operating temperatures of the fluid property look-up table and an applicable pressure being within the range of operating pressures of the fluid property look-up table, the applicable values of fluid properties for fluids (oil, water, and/or gas) may be interpolated. Responsive to the applicable temperature being outside the range of operating temperatures of the fluid property look-up table or the applicable pressure being outside the range of operating pressures of the fluid property look-up table, the use of the fluid property look-up table by the flowmeter to measure the flowrates of fluids in the pipe may be stopped.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for configuring flowmeters.

FIG. 2 illustrates an example method for configuring flowmeters.

FIG. 3 illustrates example deviations of polynomials fitted to fluid properties.

FIG. 4 illustrates an example flow diagram for measuring fluid flowrates.

### DETAILED DESCRIPTION

The present disclosure relates to configuring flowmeters to directly use a fluid property look-up table to measure fluid flowrates in a pipe. Measured values of fluid properties for oil, gas, and water at particular operating temperature and operating pressure in a pipe are used to develop fluid phase equilibrium model to calculate fluid properties at other operating temperatures and operating pressures in the pipe. The developed fluid phase equilibrium model is used to generate a fluid property look-up table that establishes correspondence between values of operating temperatures and operating pressures and values of fluid properties for oil, gas, and water. A flowmeter is configured to directly use the fluid property look-up table to measure flowrates of oil, gas, and water in the pipe.

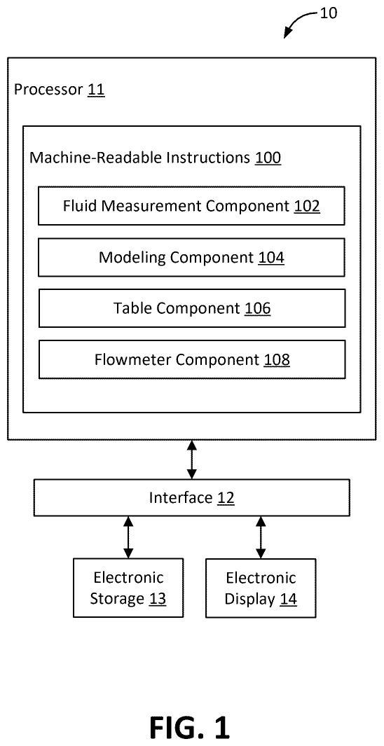

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, an electronic display 14, and/or other components. The system 10 may include one or more flowmeters. Measured values of fluid properties for oil, gas, and water in a pipe at an operating temperature and an operating pressure may be obtained by the processor 11. Fluid phase equilibrium modeling for the pipe may be performed by the processor 11 based on the measured values of fluid properties for oil, gas, and water in the pipe at the operating temperature and the operating pressure.

The fluid phase equilibrium modeling may be performed to determine modeled values of fluid properties for oil, gas, and water in the pipe at different operating temperatures and different operating pressures. A fluid property look-up table may be generated by the processor 11 based on the modeled values of fluid properties for oil, gas, and water in the pipe at the different operating temperatures and the different operating pressures and/or other information. The fluid property look-up table may establish correspondence between values of operating temperatures and operating pressures and values of fluid properties for oil, gas, and water. A flowmeter may be configured by the processor 11 to directly use the fluid property look-up table to measure flowrates of oil, gas, and water in the pipe.

The electronic storage 13 may include electronic storage media that electronically stores information. The electronic storage 13 may store software algorithms, information determined by the processor 11, information received remotely, and/or other information that enables the system 10 to function properly. For example, the electronic storage 13 may store information relating to fluid, information relating to fluid properties, information relating to oil, information relating to gas, information relating to water, information relating to a pipe, information relating to operating temperatures, information relating to operating pressures, information relating to fluid phase equilibrium modeling, information relating to a fluid property look-up table, information relating to a flowmeter, and/or other information.

The electronic display 14 may refer to an electronic device that provides visual presentation of information. The electronic display 14 may include a color display and/or a non-color display. The electronic display 14 may be configured to visually present information. The electronic display 14 may present information using/within one or more graphical user interfaces. For example, the electronic display 14 may present information relating to fluid, information relating to fluid properties, information relating to oil, information relating to gas, information relating to water, information relating to a pipe, information relating to operating temperatures, information relating to operating pressures, information relating to fluid phase equilibrium modeling, information relating to a fluid property look-up table, information relating to a flowmeter, and/or other information.

A flowmeter may be used to measure flowrates of fluid in a pipe. Measuring flowrates of fluid in a pipe may refer to ascertaining, calculating, determining, estimating, and/or otherwise measuring the flowrates of fluid in the pipe. For example, a flowmeter may be used to measure flowrates of oil, gas, and water in a pipe. A flowmeter may use properties of the fluid to measure the flowrates of fluid. For example, oil, gas, and water fluid properties (phase properties) may be used by a flowmeter to convert mass flowrates of each phase to volumetric flowrates at line condition (with gas dissolved in oil) and standard condition (without gas dissolved in oil). Different values of fluid properties over operating conditions (temperature and pressure) may be used to configure a flowmeter.

For example, polynomials may be fitted to different values of fluid properties for oil, gas, and water over broad ranges of operating temperatures and operating pressures. Different polynomials may be fitted for different types of fluid properties. The coefficients of the polynomials may be loaded onto a flowmeter, and the flowmeter may use the coefficients to build the polynomials internally. The polynomials may be used by the flowmeter to predict the values of fluid properties at different operating temperatures and operating pressures. However, such predicted values of fluid properties may carry large errors. The sources of error include (1) deficiency of fitted polynomials to properly reflect the actual values of fluid properties at different operating temperatures and operating pressures; and (2) the values of fluid properties for which the polynomials are fitted not reflecting current values of fluid properties (e.g., due to changes in a subsurface region, such as a result of ongoing production in a reservoir). Such error in the predicted values of fluid properties may result in flowrate measurement error (e.g., ˜10% error in fluid flowrate measurement).

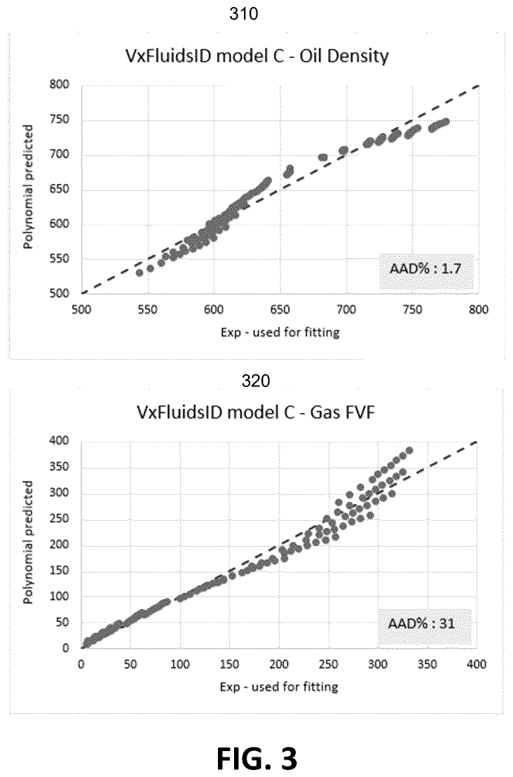

FIG. 3 illustrates example deviations of polynomials fitted to fluid properties. A graph 310 shows (1) a plot of oil density values predicted from a fitted polynomial against (2) oil density values that were used to fit the polynomial. The predicted values of oil density deviates from the values of oil density, with an average absolute deviation of 1.7%. A graph 320 shows (1) a plot of gas formation volume factor predicted from a fitted polynomial against (2) gas formation volume factor values that were used to fit the polynomial. The predicted values of gas formation volume factor deviate from the values of gas formation volume factor, with an average absolute deviation of 31%.

Rather than configuring flowmeters to calculate fluid properties values using fitted polynomial, the present disclosure configures flowmeters to calculate fluid properties values via linear interpolation of values in a fluid property look-up table (a black oil table). Eliminating fitted polynomials and directly using the fluid property look-up table eliminates deficiency of fitted polynomials. The fluid property look-up table idea may be used for other purposes. For example, the fluid property look-up table may be used with process calculations. The fluid property look-up table may be used to interpolate values of fluid properties for use in operating pipelines, compressor stations, pump stations, and/or other equipment for production/transportation of fluids.

To address changes in fluid properties, the fluid property look-up table may be updated using updated measurements. For example, a fluid property look-up table may be generated using field measurements from a reservoir prior to start of production. During production, updated field measurements may be taken and used to update the fluid property look-up table.

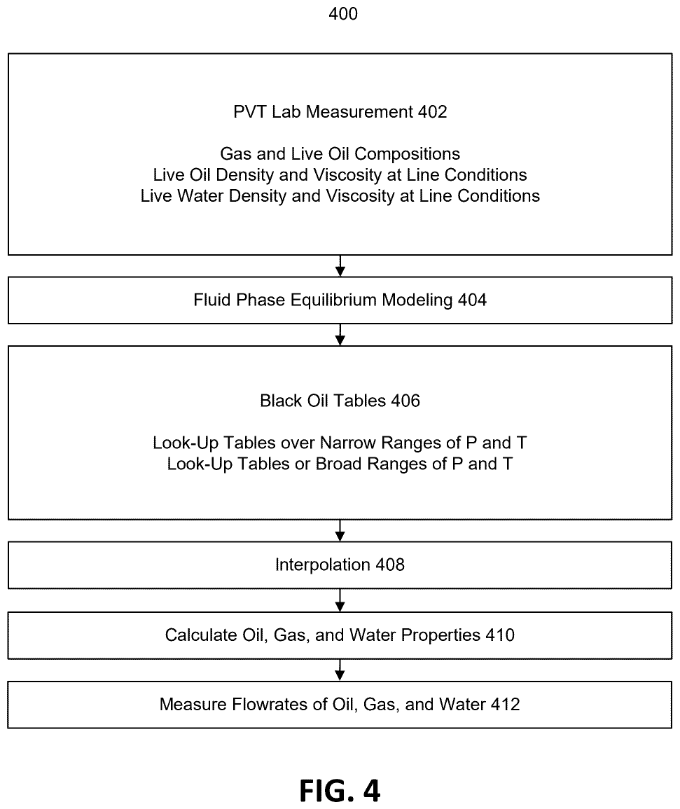

FIG. 4 illustrates an example flow diagram 400 for measuring fluid flowrates. Input data may be obtained via PVT lab measurement 402. The PVT lab measurement 402 may include measurement of gas and live oil compositions, live oil density and viscosity at line conditions, and live water density and viscosity at line conditions.

The field (at site) measurement may include measurement of gas density at standard temperature and pressure, dead oil density and viscosity at standard temperature and pressure, and dead water density and viscosity at standard temperature and pressure. The measured dead oil / water data in field (at site) may be used with black oil tables to calculate the fluid properties at line conditions. The black oil tables may include correlation between different values of fluid properties for different temperatures and different pressures.

The PVT lab measurement 402 may be used to perform fluid phase equilibrium modeling 404. The fluid phase equilibrium modeling 404 may include simulation of fluid phase behavior over ranges of temperatures and pressures. The fluid phase equilibrium modeling 404 may include generation of a fluid phase equilibrium model for fluid inside a pipe using the PVT lab measurement 402. The fluid phase equilibrium model (e.g., equation of state-based phase behavior model) may be tuned to the values from the PVT lab measurements 402. The fluid phase equilibrium modeling 404 may be performed to determine (model, calculate) values of fluid properties for temperatures and pressures different from those at which the PVT lab measurement 402 was performed. Values of fluid properties over one or more ranges of temperature and pressure may be determined. For a given temperature value within a range of temperature, values of fluid properties may be determined over a range of pressure values. Values of fluid properties over narrow ranges of temperature and pressure (i.e., wellhead to standard conditions) may be determined. Values of fluid properties over broad ranges of temperature and pressure (i.e., downhole to standard conditions) may be determined. Different ranges of temperature may not overlap.

The ranges of temperature and pressure to be used may depend on temperature and pressure over which operations are expected. The steps of temperature and pressure may depend on or be independent of the size of the ranges. For example, smaller steps of temperature and pressure may be used for narrow ranges of temperature and pressure and larger steps of temperature and pressure may be used for broad ranges of temperature and pressure, or the same steps of temperature and pressure may be used for both narrow and broad ranges of temperature and pressure.

The modeled/calculated values of fluid properties over ranges of temperatures and pressures may be used to generate black oil tables (look-up tables) 406 for the fluid properties. The black oil tables 406 may define the relationship between different values of fluid properties for different temperatures and different pressures..

The black oil tables 406 may be used to calculate fluid properties of oil, gas, and water 410. The black oil tables 406 may be used to calculate fluid properties of oil, gas, and water at line conditions. The fluid properties of oil, gas, and water may be calculated via interpolation 408. When the black oil table 406 does not include the values of fluid properties for a combination of temperature and pressure, the nearby/closest values of fluid properties (the values of fluid properties in the black oil table 406 that is above and below the relevant temperature and pressure) may be interpolated to calculate the values of fluid properties for the combination of temperature and pressure. Such calculations of fluid property values may be more accurate than the use of fitted polynomials to calculate fluid property values. The calculated fluid properties of oil, gas, and water may be used to determine flowrates of oil, gas, and water in a pipe 412.

The process shown in the flow diagram 400 may be repeated to update the black oil tables 406. For example, reservoir depletion due to production may change properties of the reservoir fluid, and the process may be repeated during production so that the black oil tables 406 are updated to accurately reflect current conditions of the reservoir fluid.

Referring back to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate configuring flowmeters. The machine-readable instructions 100 may include one or more computer program components. The machine-readable instructions 100 may include one or more of a fluid measurement component 102, a modeling component 104, a table component 106, a flowmeter component 108, and/or other computer program components.

The fluid measurement component 102 may be configured to obtain measured values of fluid properties for one or more fluids in a pipe. Obtaining a measured value of a fluid property may include one or more of accessing, acquiring, analyzing, determining, examining, generating, identifying, loading, locating, measuring, opening, receiving, retrieving, reviewing, selecting, storing, and/or otherwise obtaining the measured value of the fluid property. The fluid measurement component 102 may obtain measured values of fluid properties for one or more fluids in a pipe from one or more locations. For example, the fluid measurement component 102 may obtain a measured value of a fluid property a storage location, such as the electronic storage 13, electronic storage of a device accessible via a network, and/or other locations. The fluid measurement component 102 may obtain a measured value of a fluid property from one or more hardware components (e.g., a computing device, a fluid property sensor) and/or one or more software components (e.g., software running on a computing device). The fluid measurement component 102 may obtain a measured value of a fluid property from one or more users (e.g., entry of fluid property values into the system 10 by a user).

A pipe may refer to a tube used to convey materials. A pipe may be used to convey and/or hold one or more types of fluid. Fluid may refer to a substance that has no fixed shape. Fluid may refer to material that may continuously move and/or deform under external force, such as material liquid or gas form. For example, a pipe may convey and/or hold oil, gas, water, and/or other types of fluids. The fluid measurement component 102 may be configured to obtain measured values of fluid properties for oil, gas, water, and/or other types of fluids in the pipe.

A fluid property may refer to an attribute, quality, or characteristic of the fluid. A fluid property may be static or dynamic. For example, the fluid properties for fluids (oil, gas, and/or water) may include oil density, oil volume factor, oil viscosity, gas density, gas volume factor, gas phase condensate ratio, stock tank gas-oil ratio, water density, water volume factor, water viscosity, stock tank gas-water ratio, and/or other fluid properties.

The measured values of fluid properties for fluid(s) may be obtained at one or more operating temperatures and one or more operating pressures. For example, the measured values of fluid properties for oil, gas, water, and/or other fluids may be obtained at one or more operating temperatures and one or more operating pressure. An operating temperature may refer to the temperature at which the pipe is operated.

An operating temperature may refer to the temperature at which the fluid(s) are being held and/or conveyed by the pipe. An operating temperature may refer to the temperature of the pipe and/or the temperature of the fluid at which values of fluid properties are measured. An operating pressure may refer to the pressure at which the pipe is operated. An operating pressure may refer to the pressure at which the fluid(s) are being held and/or conveyed by the pipe. An operating pressure may refer to the pressure inside the pipe and/or the pressure acting on the fluid at which values of fluid properties are measured.

The measured values of fluid properties may be obtained at specific temperature(s) and/or specific pressure(s). The measured values of fluid properties may be obtained from the field/site of the pipe and/or through laboratory analysis (e.g., the field (at site) measurement 402, the PVT lab measurement 404). The measured values of fluid properties may be obtained through analysis of physically collected fluid (oil, gas, and/or water) samples from the field.

In some implementations, the pipe may be located at a reservoir. A reservoir may refer to a location at which one or more resources are stored. For example, a reservoir may refer to a location at which hydrocarbons are stored. For instance, a reservoir may refer to a location including rocks in which oil, gas, and/or water have accumulated. A reservoir may include regions below the surface. A reservoir may include one or more wells. For example, a reservoir may include one or more injection wells (e.g., for injection of fluid), one or more production wells (e.g., for extraction of oil or gas), and/or other wells. The term “subsurface region,” “formation,” “subsurface formation,” “subterranean formation,” “subsurface volume of interest,” “subsurface region of interest,” and the like may be utilized interchangeably with the term “reservoir.”

The measured values of fluid properties for fluids (oil, gas, and/or water) in the pipe may be obtained at beginning of production from the reservoir. Production may refer to extraction/retrieval of resources from the reservoir. Initial values of fluid properties may be measured at the beginning of production from the reservoir (e.g., before the start of commercial production).

In some implementations, updated values of fluid properties for fluids (oil, gas, and/or water) in the pipe may be obtained during the production from the reservoir. Production from the reservoir may change the properties of the reservoir and reservoir fluid. The initial values of fluid properties measured at the beginning of production from the reservoir may not reflect the actual values of fluid properties during production from the reservoir. Updated values of fluid properties may be measured during the production from the reservoir. Updated values of fluid properties may be measured one or more times during the production from the reservoir.

The modeling component 104 may be configured to perform fluid phase equilibrium modeling for the pipe. Fluid phase equilibrium modeling may refer to computer calculation/computation of how fluids act. Fluid phase equilibrium modeling may refer to computer calculation/computation of fluid properties under different conditions. Fluid phase equilibrium modeling may utilize one or more relationships between fluid properties, temperatures, and pressures to model (e.g., calculate, simulate, predict) fluid properties. For example, fluid phase equilibrium modeling may include an equation-of-state based phase equilibrium modeling that utilizes relationships between volume, pressure, and temperature to model fluid properties. Fluid phase equilibrium modeling may utilize a thermodynamic model and/or a phase behavior model to model fluid properties under different conditions.

The fluid phase equilibrium modeling may be performed based on the measured values of fluid properties for fluids (oil, gas, and/or water) in the pipe at the operating temperature(s) and the operating pressure(s). The fluid phase equilibrium modeling may be performed to determine modeled (calculated, simulated) values of fluid properties for fluids (oil, gas, and/or water) in the pipe at different operating temperatures and different operating pressures. Performing fluid phase equilibrium modeling may include developing a fluid phase equilibrium model that represents fluids in the pipe using the measured fluid properties, and using the developed fluid phase equilibrium model to predict fluid properties at other temperatures and pressures. The measured values of fluid properties may be input into the fluid phase equilibrium modeling to model the values of fluid properties at other temperatures and pressures. The fluid phase equilibrium modeling may be performed using the measured values of fluid properties to predict values of fluid properties at other temperatures and pressures. The fluid phase equilibrium modeling may be performed to model values of fluid properties over narrow ranges of temperature and/or pressure (i.e., wellhead to standard conditions). The fluid phase equilibrium modeling may be performed to model values of fluid properties by simulating small changes in temperature and/or pressure. The fluid phase equilibrium modeling may be performed to model values of fluid properties over broad ranges of temperature and/or pressure (i.e., downhole to standard conditions). The fluid phase equilibrium modeling may be performed to model values of fluid properties by simulating large changes in temperature and/or pressure.

In some implementations, the fluid phase equilibrium modeling may be reperformed based on the updated values of fluid properties for fluids (oil, gas, and/or water) in the pipe to determine new modeled values of fluid properties for fluids in the pipe. For example, the fluid phase equilibrium modeling may be performed using initial values of fluid properties measured at the beginning of production from a reservoir to model fluid properties at different temperatures and pressures. Production from the reservoir may change the properties of the reservoir, making the initially modeled values of fluid properties less accurate. Fluid phase equilibrium modeling may be reperformed using updated values of fluid properties measured during production to update the modeled values of fluid properties at different temperatures and pressures.

The table component 106 may be configured to generate one or more fluid property look-up tables. Generating a fluid property look-up table may include calculating, constructing, creating, determining, making, producing, and/or otherwise generating the fluid property look-up table. A fluid property look-up table may refer to an array of information that maps (establish correspondence between) values of temperature and pressures to values of a fluid property. In some implementations, a fluid property look-up table may include a black oil table.

One or more fluid property look-up tables may be generated for individual fluid properties (e.g., a fluid property look-up table maps different combinations of temperature and pressures to values of a single fluid property). A fluid property look-up table may be generated for multiple fluid properties (e.g., a fluid property look-up table maps different combinations of temperature and pressures to values of multiple fluid properties).

A fluid property look-up table may be generated based on the modeled values of fluid properties for fluids (oil, gas, and/or water) in the pipe at the different operating temperatures and the different operating pressures and/or other information. A fluid property look-up table may be populated with measured values of fluid properties and corresponding operating temperature(s) and operating pressure(s). A fluid property look-up table may be populated with modeled values of fluid properties and corresponding operating temperature(s) and operating pressure(s).

Fluid property look-up tables may establish correspondence between values of operating temperatures and operating pressures and values of fluid properties for fluids (oil, gas, and/or water). Specific values of fluid properties may be mapped to specific combination of values of operation temperatures and operation pressures.

A fluid property look-up table may establish correspondence between the values of operating temperatures and operating pressures and the values of fluid properties for fluids for one or more ranges of operating temperatures and one or more ranges of operating pressures. A fluid property look-up table may be populated to cover one or more ranges of operating temperatures and/or one or more ranges of operating pressures. A fluid property look-up table may be populated to cover a narrow range of temperature (i.e., wellhead to standard conditions), a broad range of temperature (i.e., downhole to standard conditions), a narrow range of pressure (i.e., wellhead to standard conditions), and/or a broad range of pressure (i.e., downhole to standard conditions). A single fluid property look-up table may be generated to cover multiple ranges of temperature and pressure. Different fluid property look-up tables may be generated for different ranges of temperature and/or pressure.

In some implementations, one or more updated fluid property look-up tables may be generated based on the new modeled values of fluid properties for fluids (oil, gas, and/or water in the pipe and/or other information. The fluid property look-up table(s) may be initially populated with values of fluid properties measured and/or modeled at the beginning of production from a reservoir. The fluid property look-up table(s) may later be updated with values of fluid properties measured during production from the reservoir and/or newly modeled values of fluid properties (modeled using the newly measured values of fluid properties). The fluid property look-up table(s) may be updated to reflect changes in the properties of the reservoir.

The flowmeter component 108 may be configured to configure one or more flowmeters. A flowmeter may refer to a device for measuring the rate of flow of a fluid. A flowmeter may refer to a physical flowmeter, such as a multiphase flowmeter, or a virtual flowmeter, such as a mathematical model that uses process conditions to estimate flowrates (e.g., virtual flow metering). A flowmeter may be used to measure individual phase flowrates of constituent phases in a given flow. A flowmeter may be used to measure (calculate, compute, determine, estimate) flowrates of fluids (oil, gas, and/or water) in the pipe. A flowmeter may be configured to directly use the fluid property look-up table(s) to measure flowrates of fluids (oil, gas, and/or water) in the pipe. A flowmeter may be configured to directly use the updated fluid property look-up table(s) to measure the flowrates of fluids in the pipe.

Configuring a flowmeter may include one or more of preparing, setting up, and/or otherwise configuring the flowmeter. Configuring a flowmeter may include directing/instructing the flowmeter to use the fluid property look-up table(s) to measure the flowrates of fluids in the pipe. A flowmeter may be configured to directly use the fluid property look-up table(s) without using polynomials fitted to the values of operating temperatures and operating pressures and the values of fluid properties for fluids (oil, gas, and/or water) in the fluid property look-up table. A flowmeter may be configured to directly use the fluid property look-up table(s) without using fitted polynomials to the values of fluid properties for oil, gas, and water over ranges of operating temperatures and operating pressures in the fluid property look-up table(s). Rather than configuring a flowmeter to determine relevant values of fluid properties at various temperatures and pressures using polynomials fitted to values of fluid properties, temperatures, and pressures, the flowmeter may be configured to determine relevant values of fluid properties directly from the fluid property look-up table(s).

To measure the flowrates of fluids at particular temperature and pressure, the flowmeter may obtain relevant values of fluid properties by finding the fluid properties values in the fluid property look-up table(s) that corresponds to the particular temperature and pressure. For example, if a fluid property look-up table includes a value of fluid property corresponding to the current operating temperature and operating pressure of the pipe, this corresponding value of fluid property may be pulled for use in measuring the flowrates of fluids in the pipe. If a fluid property look-up table does not include a value of fluid property corresponding to the current operating temperature and operating pressure of the pipe, the value of fluid property may be computed from nearby/closest values of fluid properties. A flowmeter may interpolate between the values of operating temperatures and operating pressures and the values of fluid properties for fluids (oil, water, and/or gas) in the fluid property look-up table(s) to determine applicable values of fluid properties for fluids in measuring the flowrates of fluids in the pipe. For example, a flowmeter may interpolate between the values of fluid properties for oil, water, and gas corresponding to operating temperatures and operating pressures in the fluid property look-up table to determine applicable values of fluid properties for oil, water, and gas in measuring the flowrates of oil, water, and gas in the pipe.

Direct use of a fluid property look-up table by the flowmeter may be contingent on the applicable temperature and applicable pressure for flowrate measurement being within the range(s) of operating temperatures and the range(s) of operating pressures of the fluid property look-up table. Responsive to the applicable temperature being within the range(s) of operating temperatures of the fluid property look-up table and the applicable pressure being within the range(s) of operating pressures of the fluid property look-up table, the applicable values of fluid properties for fluids (oil, water, and/or gas) may be interpolated (using the nearby/closest values of fluid properties, using values in the fluid property look-up table that is above and below the applicable temperature and/or the applicable pressure).

Responsive to the applicable temperature being outside the range of operating temperatures of the fluid property look-up table or the applicable pressure being outside the range of operating pressures of the fluid property look-up table, the use of the fluid property look-up table by the flowmeter to measure the flowrates of fluids in the pipe may be stopped. For example, an error may be generated and/or the fluid property look-up table may be updated (e.g., using new measurements of fluid properties, using new modeling of fluid properties) to expand the range of operating temperatures and/or the range of operating pressures. A specific value (e.g., 0, 1, last known/valid value of fluid properties) may be output. An alarm/alert may be generated to inform the user of the flowmeter that the applicable temperature and/or the applicable pressure are outside the range of operating temperatures and/or the range of operating pressures of the fluid property look-up table.

For example, a fluid property look-up table may be missing the fluid property value for temperature/pressure above or below the operating temperature/pressure of the pipe. Since the fluid property value for the operating temperature/pressure of the pipe cannot be interpolated from the fluid property look-up table, use of the fluid property look-up table by the flowmeter may be stopped. Use of the fluid property look-up table at the particular combination of temperature and pressure may be allowed once the fluid property look-up table is updated/ranges of the fluid property look-up table are expanded. If the flowmeter was configured to use fitted polynomials to determine the fluid property values, the fluid property value may be predicted using the fitted polynomials even when the underlying data used to fit the polynomial does not support the prediction. The predicted fluid property value may be inaccurate, and the flowmeter may output inaccurate flowrate measurement without alerting the user as to the potential problem with the measurement. The direct use of fluid property look-up table by the flowmeter results in higher accuracy of flowrate measurement when operating temperature/pressure is within the scope of the fluid property look-up table and understanding of when operating temperature/pressure is beyond the scope of the fluid property look-up table.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible (non-transitory) computer-readable storage medium may include read-only memory, random access memory, magnetic disk storage media, optical storage media, flash memory devices, and others, and a machine-readable transmission medium may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the electronic display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network.

For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the electronic display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

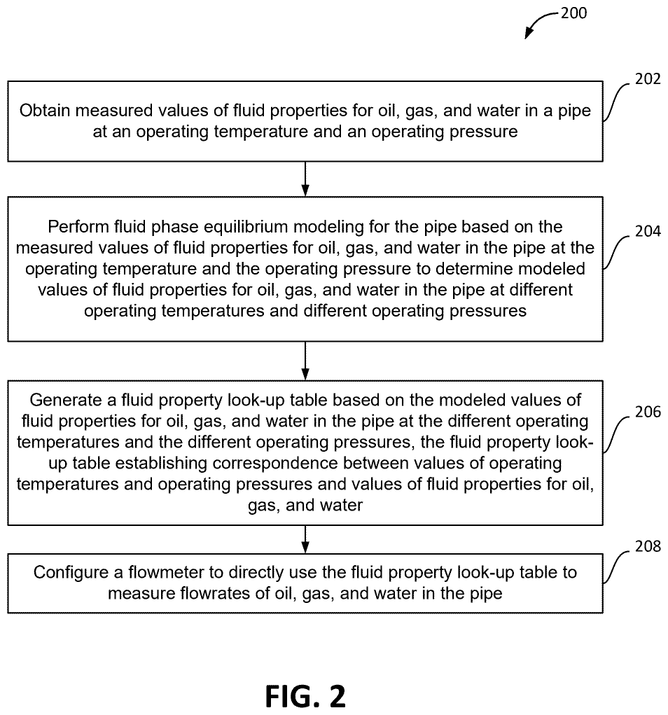

FIG. 2 illustrates method 200 for configuring flowmeters. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, at operation 202, measured values of fluid properties for oil, gas, and water in a pipe at an operating temperature and an operating pressure may be obtained. In some implementations, operation 202 may be performed by a processor component the same as or similar to the fluid measurement component 102 (Shown in FIG. 1 and described herein).

At operation 204, fluid phase equilibrium modeling for the pipe may be performed based on the measured values of fluid properties for oil, gas, and water in the pipe at the operating temperature and the operating pressure. The fluid phase equilibrium modeling may be performed to determine modeled values of fluid properties for oil, gas, and water in the pipe at different operating temperatures and different operating pressures. In some implementations, operation 204 may be performed by a processor component the same as or similar to the modeling component 104 (Shown in FIG. 1 and described herein).

At operation 206, a fluid property look-up table may be generated based on the modeled values of fluid properties for oil, gas, and water in the pipe at the different operating temperatures and the different operating pressures and/or other information. The fluid property look-up table may establish correspondence between values of operating temperatures and operating pressures and values of fluid properties for oil, gas, and water. In some implementations, operation 206 may be performed by a processor component the same as or similar to the table component 106 (Shown in FIG. 1 and described herein).

At operation 208, a flowmeter may be configured to directly use the fluid property look-up table to measure flowrates of oil, gas, and water in the pipe. The flowmeter may interpolate between the values of operating temperatures and operating pressures and the values of fluid properties for fluids (oil, water, and/or gas) in the fluid property look-up table to determine applicable values of fluid properties for fluids in measuring the flowrates of fluids in the pipe. In some implementations, operation 208 may be performed by a processor component the same as or similar to the flowmeter component 108 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for configuring flowmeters, the system comprising:
one or more physical processors configured by machine-readable instructions to:
obtain measured values of fluid properties for oil, gas, and water in a pipe at an operating temperature and an operating pressure;
perform fluid phase equilibrium modeling for the pipe based on the measured values of fluid properties for oil, gas, and water in the pipe at the operating temperature and the operating pressure to determine modeled values of fluid properties for oil, gas, and water in the pipe at different operating temperatures and different operating pressures;
generate a fluid property look-up table based on the modeled values of fluid properties for oil, gas, and water in the pipe at the different operating temperatures and the different operating pressures, the fluid property look-up table establishing correspondence between values of operating temperatures and operating pressures and values of fluid properties for oil, gas, and water; and
configure a flowmeter to directly use the fluid property look-up table to measure flowrates of oil, gas, and water in the pipe, wherein the flowmeter interpolates between the values of operating temperatures and operating pressures and the values of fluid properties for oil, water, and gas in the fluid property look-up table to determine applicable values of fluid properties for oil, water, and gas in measuring the flowrates of oil, water, and gas in the pipe.

2. The system of claim 1, wherein process calculation is performed based on the fluid property look-up table.

3. The system of claim 1, wherein the fluid property look-up table includes a black oil table.

4. The system of claim 1, wherein the fluid properties for oil, gas, and water include oil density, oil volume factor, oil viscosity, gas density, gas volume factor, gas phase condensate ratio, stock tank gas-oil ratio, water density, water volume factor, water viscosity, and stock tank gas-water ratio.

5. The system of claim 1, wherein the pipe is located at a reservoir, and the measured values of fluid properties for oil, gas, and water in the pipe are obtained at beginning of production from the reservoir.

6. The system of claim 1, wherein:
updated values of fluid properties for oil, gas, and water in the pipe are obtained during the production from the reservoir;
the fluid phase equilibrium modeling is reperformed based on the updated values of fluid properties for oil, gas, and water in the pipe to determine new modeled values of fluid properties for oil, gas, and water in the pipe;
an updated fluid property look-up table is generated based on the new modeled values of fluid properties for oil, gas, and water in the pipe; and
the flowmeter is configured to directly use the updated fluid property look-up table to measure the flowrates of oil, gas, and water in the pipe.

7. The system of claim 1, wherein the flowmeter is configured to directly use the fluid property look-up table without using polynomials fitted to the values of operating temperatures and operating pressures and the values of fluid properties for oil, gas, and water in the fluid property look-up table.

8. The system of claim 1, wherein the fluid property look-up table establishes correspondence between the values of operating temperatures and operating pressures and the values of fluid properties for oil, gas, and water for a range of operating temperatures and a range of operating pressures.

9. The system of claim 8, wherein responsive to an applicable temperature being within the range of operating temperatures of the fluid property look-up table and an applicable pressure being within the range of operating pressures of the fluid property look-up table, the applicable values of fluid properties for oil, water, and gas are interpolated.

10. The system of claim 9, wherein responsive to the applicable temperature being outside the range of operating temperatures of the fluid property look-up table or the applicable pressure being outside the range of operating pressures of the fluid property look-up table, the use of the fluid property look-up table by the flowmeter to measure the flowrates of oil, gas, and water in the pipe is stopped.

11. A method for configuring flowmeters, the method comprising:
obtaining measured values of fluid properties for oil, gas, and water in a pipe at an operating temperature and an operating pressure;
performing fluid phase equilibrium modeling for the pipe based on the measured values of fluid properties for oil, gas, and water in the pipe at the operating temperature and the operating pressure to determine modeled values of fluid properties for oil, gas, and water in the pipe at different operating temperatures and different operating pressures;
generating a fluid property look-up table based on the modeled values of fluid properties for oil, gas, and water in the pipe at the different operating temperatures and the different operating pressures, the fluid property look-up table establishing correspondence between values of operating temperatures and operating pressures and values of fluid properties for oil, gas, and water; and
configuring a flowmeter to directly use the fluid property look-up table to measure flowrates of oil, gas, and water in the pipe, wherein the flowmeter interpolates between the values of operating temperatures and operating pressures and the values of fluid properties for oil, water, and gas in the fluid property look-up table to determine applicable values of fluid properties for oil, water, and gas in measuring the flowrates of oil, water, and gas in the pipe.

12. The method of claim 11, wherein process calculation is performed based on the fluid property look-up table.

13. The method of claim 11, wherein the fluid property look-up table includes a black oil table.

14. The method of claim 11, wherein the fluid properties for oil, gas, and water include oil density, oil volume factor, oil viscosity, gas density, gas volume factor, gas phase condensate ratio, stock tank gas-oil ratio, water density, water volume factor, water viscosity, and stock tank gas-water ratio.

15. The method of claim 11, wherein the pipe is located at a reservoir, and the measured values of fluid properties for oil, gas, and water in the pipe are obtained at beginning of production from the reservoir.

16. The method of claim 11, wherein:
updated values of fluid properties for oil, gas, and water in the pipe are obtained during the production from the reservoir;
the fluid phase equilibrium modeling is reperformed based on the updated values of fluid properties for oil, gas, and water in the pipe to determine new modeled values of fluid properties for oil, gas, and water in the pipe;
an updated fluid property look-up table is generated based on the new modeled values of fluid properties for oil, gas, and water in the pipe; and
the flowmeter is configured to directly use the updated fluid property look-up table to measure the flowrates of oil, gas, and water in the pipe.

17. The method of claim 11, wherein the flowmeter is configured to directly use the fluid property look-up table without using polynomials fitted to the values of operating temperatures and operating pressures and the values of fluid properties for oil, gas, and water in the fluid property look-up table.

18. The method of claim 11, wherein the fluid property look-up table establishes correspondence between the values of operating temperatures and operating pressures and the values of fluid properties for oil, gas, and water for a range of operating temperatures and a range of operating pressures.

19. The method of claim 18, wherein responsive to an applicable temperature being within the range of operating temperatures of the fluid property look-up table and an applicable pressure being within the range of operating pressures of the fluid property look-up table, the applicable values of fluid properties for oil, water, and gas are interpolated.

20. The method of claim 19, wherein responsive to the applicable temperature being outside the range of operating temperatures of the fluid property look-up table or the applicable pressure being outside the range of operating pressures of the fluid property look-up table, the use of the fluid property look-up table by the flowmeter to measure the flowrates of oil, gas, and water in the pipe is stopped.
